(19) United States
(12) Patent Application Publication
(10) Pub. No.: US 2011/0051761 A1
(43) Pub. Date: Mar. 3, 2011

(54) OPERATING METHOD OF EXCIMER LASER SYSTEM

(76) Inventors: JIANZHONG LU, Singapore (SG); SHIBIN LIU, Singapore (SG)

(21) Appl. No.: 12/548,452

(22) Filed: Aug. 27, 2009

(51) Int. Cl. H01S 3/00; H01S 3/22; H01S 3/223

(52) U.S. Cl. 372/38.02; 372/57; 372/58

(57) ABSTRACT

An operating method of an excimer laser system includes following steps. First, a halogen gas with an injection volume is injected into a chamber until a pressure of the chamber is a total pressure. The halogen gas in the chamber has a halogen pressure. Thereafter, a driving voltage is provided between two electrodes in the chamber so as to start the excimer laser system. The halogen pressure and a full width half maximum of a laser light generated by the excimer laser system have negative relation, and the halogen pressure and the driving voltage have positive relation.

### BACKGROUND OF THE INVENTION

1. Field of the Invention

The present invention relates to an operating method of an excimer laser system, and more particularly, to an operating method of an excimer laser system for increasing the lifetime of the excimer laser system.

2. Description of the Prior Art

Due to being able to generate deep ultraviolet (DUW) or vacuum ultraviolet (VUW) light, pulsed gas discharge lasers, such as excimer laser, have been an indispensable device for the photolithographic process.

Please refer to FIG. 1, which is a schematic diagram illustrating an excimer laser system according to the prior art. As shown in FIG. 1, the excimer laser system 10 includes a chamber 12, two electrodes 14, 16 disposed in the chamber 12 and provided with a voltage difference, a heat exchanger 18 disposed in the chamber 12, and a gas cycling fan 20 disposed in the chamber 12. The chamber 12 is filled with fluorine, krypton and neon. In the chamber 12, the fluorine is ionized by the voltage difference between the electrodes 14, 16, and reacts with the krypton and the neon to form excited dimer of krypton fluoride (KrF), which is called excimer. Because the excited dimer is in an excited state, which is an unstable energy state, the excimer will trend toward a more stable energy state so as to be dissociated and radiate ultraviolet (UW) light.

However, whether the excimer laser system operates or not, the fluorine still will react with krypton and neon because of being high reactive. Accordingly, the volume of the fluorine in the chamber gradually decreases, so that the fluorine in the excimer laser system is insufficient to be unable to provide the same output energy of the laser light as usual. In order to maintain the same output energy of the laser light of the excimer laser system, the operating method of the excimer laser system of the prior art raises the voltage difference between two electrodes to increase the reaction of the fluorine in the chamber so as to raise the output energy. Nevertheless, keeping raising the voltage difference results in the consumption of the electrodes, so that the lifetime of the chamber is shortened. Therefore, to maintain the laser light with stable output energy of the excimer laser system and simultaneously to raise the lifetime of the chamber is an important objective in the industry.

### SUMMARY OF THE INVENTION

It is therefore an objective of the present invention to provide an operating method of an excimer laser system to extend the lifetime of the chamber.

According to an embodiment of the present invention, an operating method of an excimer laser system is provided. The excimer laser system comprises a chamber, a first gas supply unit for providing a halogen gas and a second gas supply unit for providing a mixed gas. The mixed gas comprises a first inert gas and a second inert gas, and the chamber filled with a remaining reaction gas. First, the halogen gas with an injection volume is injected into the chamber until a pressure of the chamber is a total pressure, and the halogen gas in the chamber has a halogen pressure. Then, a driving voltage is provided between two electrodes in the chamber so as to start the excimer laser system. The halogen pressure and a full width half maximum (FWHM) of a laser light generated by the excimer laser system are limited to have negative relation, and the halogen pressure and the driving voltage are limited to have positive relation.

The operating method of the excimer laser system of the present invention provides the relations between the halogen gas, the driving voltage and the FWHM so as to increase the injection of the halogen gas and retard the increase of the driving voltage when the driving voltage rises. In addition, when the FWHM rises, the injection of the halogen gas is reduced so as to retard the increase of the FWHM when the FWHM rises. Therefore, the lifetime of the excimer laser system can be extended.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an excimer laser system according to the prior art.

FIG. 2 is a flow chart illustrating an operating method of an excimer laser system according to a preferred embodiment of the present invention.

FIG. 3 is a schematic diagram illustrating the excimer laser system according to the preferred embodiment of the present invention.

FIG. 4 is a schematic diagram illustrating a relation between the pressure of the chamber and the injection step according to the preferred embodiment of the present invention.

FIG. 5 is a flow chart illustrating the gas injection method according to the preferred embodiment of the present invention.

FIG. 6 is a schematic diagram illustrating a lifetime curve of the excimer laser system using the operating method of the present invention and a lifetime curve of the excimer laser system according to the prior art.

FIG. 7 is a flow chart illustrating a gas injection method according to another preferred embodiment of the present invention.

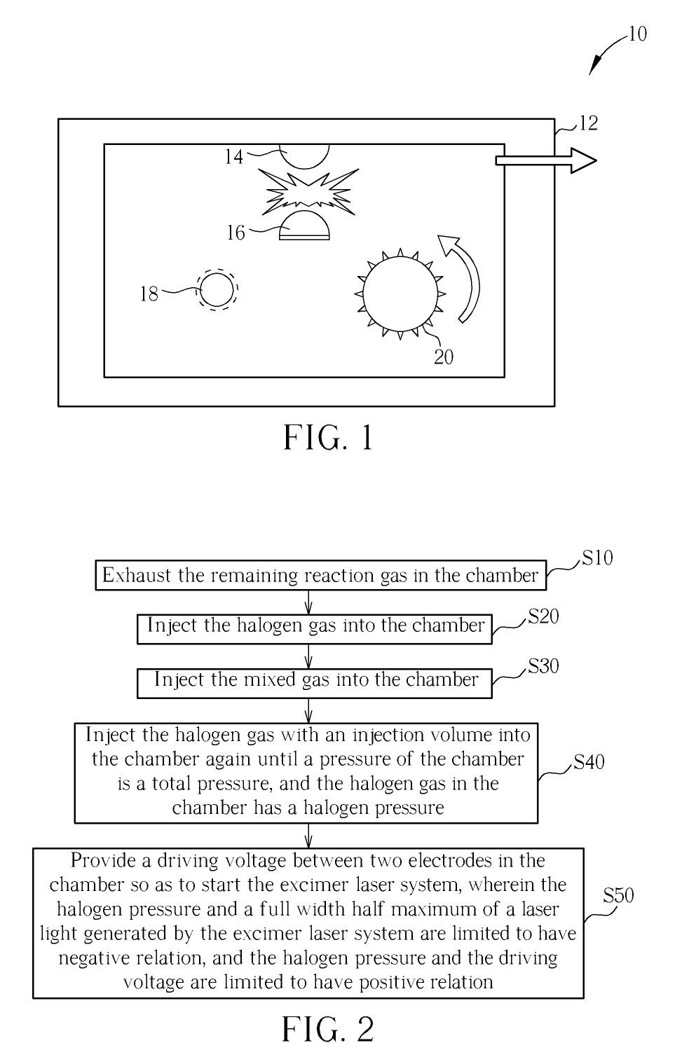

### DETAILED DESCRIPTION

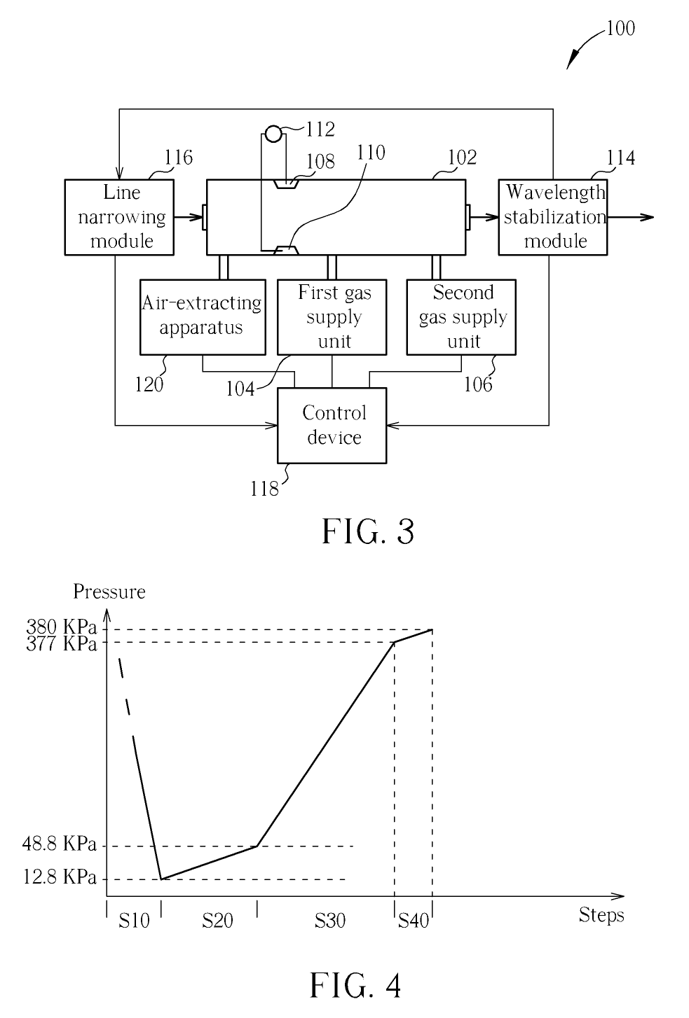

Please refer to FIG. 2 and FIG. 3. FIG. 2 is a flow chart illustrating an operating method of an excimer laser system according to a preferred embodiment of the present invention. FIG. 3 is a schematic diagram illustrating the excimer laser system according to the preferred embodiment of the present invention. The operating method of the excimer laser system of the present invention is performed after the excimer laser system is operated for a period of time, and the excimer laser system is unable to generate the laser light with stable output energy. In addition, the operating method is performed under the condition of the excimer laser system being shut down. As shown in FIG. 2 and FIG. 3, the excimer laser system 100 includes a chamber 102, a first gas supply unit 104 for providing a halogen gas and a second gas supply unit 106 for providing a mixed gas. The mixed gas includes a first inert gas and a second inert gas, and the chamber 102 is filled with a remaining reaction gas. The operating method of the excimer laser system 100 includes:

Step S10: exhaust the remaining reaction gas in the chamber 102 until the pressure of the chamber 102 is a first pressure;

Step S20: inject the halogen gas into the chamber 102 until the pressure of the chamber 102 is a second pressure;

Step S30: inject the mixed gas into the chamber 102 until the pressure of the chamber 102 is a third pressure;

Step S40: inject the halogen gas with an injection volume into the chamber 102 again until a pressure of the chamber 102 is a total pressure, and the halogen gas in the chamber 102 has a halogen pressure; and

Step S50: provide a driving voltage between two electrodes 108, 110 in the chamber 102 so as to start the excimer laser system 100, wherein the halogen pressure and a full width half maximum (FWHM) of a laser light generated by the excimer laser system 100 are limited to have negative relation, and the halogen pressure and the driving voltage are limited to have positive relation.

In order to describe in detail the steps of the operating method of the excimer laser system 100, please refer to FIG. 4, and refer to FIG. 2 and FIG. 3 again. FIG. 4 is a schematic diagram illustrating a relation between the pressure of the chamber and the injection step according to the preferred embodiment of the present invention. The pressure of the chamber 102 of the present invention takes FIG. 4 as an example, but is not limited to FIG. 4. The embodiment takes KrF excimer laser system as an example. The halogen gas is fluorine. The first inert gas is krypton, and the second inert gas is neon, but is not limited to these. When the excimer laser system 100 is in operating state, the chamber 102 is filled with fluorine, krypton and neon, and the ration of fluorine, krypton and neon is substantially 1.3:0.1:98.6, but is not limited to this ratio.

As shown in FIG. 3 and FIG. 4, in step S10 of this embodiment, an air-extracting apparatus 120 connected to the chamber 102 exhausts the remaining reaction gas in the chamber 102 so as to ensure that the remaining reaction gas in the chamber 102 will not affect the ratio of the fluorine, krypton and neon in the following injection steps. Until a control device 118 reads the first pressure as substantially 12.8 Kpa, the air-extracting apparatus 120 does not stop exhausting. Then, in step S20 of this embodiment, the control device 118 starts the first gas supply unit 102 after stopping exhausting, and the halogen gas in the first gas supply unit 104 is injected into the chamber 102 until the second pressure is substantially 45.8 Kpa. The first gas supply unit 104 is closed, and the halogen gas stops being injected. Next, in step S30 of this embodiment, when the first gas supply unit 104 is closed, the control device 118 starts the second gas supply unit 106, and the mixed gas in the second gas supply unit 106 is injected into the chamber 102 until the third pressure is substantially 377 Kpa. The second gas supply unit 106 is closed, and the mixed gas stops being injected. Thereafter, in step S40, when the second gas supply unit 106 is closed, the control device 118 starts the first gas supply unit 104 again, and the halogen with an injection volume is injected into the chamber 102 until the total pressure in the chamber 102 is substantially 380 Kpa.

In step S50, the excimer laser system 100 is started, and a pulse voltage source 112 connected between the two electrodes 108, 110 in the chamber 102 is used to provide a high pulse voltage between the electrodes 108, 110 so as to generate discharging pulse. Accordingly, the fluorine and the krypton react with electrical particles from surfaces of the electrodes 108, 110 so as to generate the laser light. A wavelength stabilization module (WSM) 114 disposed at the laser light output of the chamber 102 can measure the spectrum and the energy of the laser light generated by the excimer laser system 100, and the WSM 114 and a line narrowing module (LNM) 116 disposed at the other side of the chamber opposite to the WSM 114 can optimize the bandwidth of the excimer laser system 100 under the condition of fixing the output energy of the laser light generated by the excimer laser system 100. The driving voltage and the FWHM of the laser light can also be measured. In addition, the control device 118 electrically connected to the LNM 116 and the WSM 114 can receive information of the spectrum and the output energy of the laser light, and according to the information, the control device 118 can control the ON/OFF of the air-extracting apparatus 120 and the supplies of the first gas supply unit 104 and the second gas supply unit 106.

It should be noted that the halogen pressure, the FWHM and the driving voltage of this embodiment are limited to have a first relational equation:

C130=−80B+0.11V+160

where C130 is the halogen pressure, which has the unit of kilopascal (Kpa); B is the FWHM, which has the unit of nanometer (nm); −80 is a first coefficient, which has the unit of Kpa/nm; V is the driving voltage, which has the unit of volts (V); 0.11 is a second coefficient, which has the unit of Kpa/V; 160 is a constant, which has the unit of Kpa. The driving voltage is the pulse voltage difference provided between the electrodes 108, 110 in the chamber 102, and the FWHM is a bandwidth at half maximum intensity of the laser light measured by the WSM 114. For example, when the driving voltage has been adjusted to 1000V, and the measured FWHM is 0.5 nm, the halogen pressure is limited to 230 Kpa. However, the first coefficient, the second coefficient and the constant are not limited to these values, and the present invention can adjust the values of the first coefficient, the second coefficient and the constant depending on different laser systems.

In addition, the total pressure of the present invention also requires having positive relation with the driving voltage, and the total pressure and the driving voltage are limited to a second relational equation:

C132=0.83V+2050

where C132 is the total pressure, which has the unit of Kpa; V is the driving voltage, which has the unit of V; 0.83 is a third coefficient, which has the unit of Kpa/V; 2050 is a constant, which has the unit of Kpa. The third coefficient and the constant are not limited to these values, and the present invention also can adjust the values depending on different laser systems.

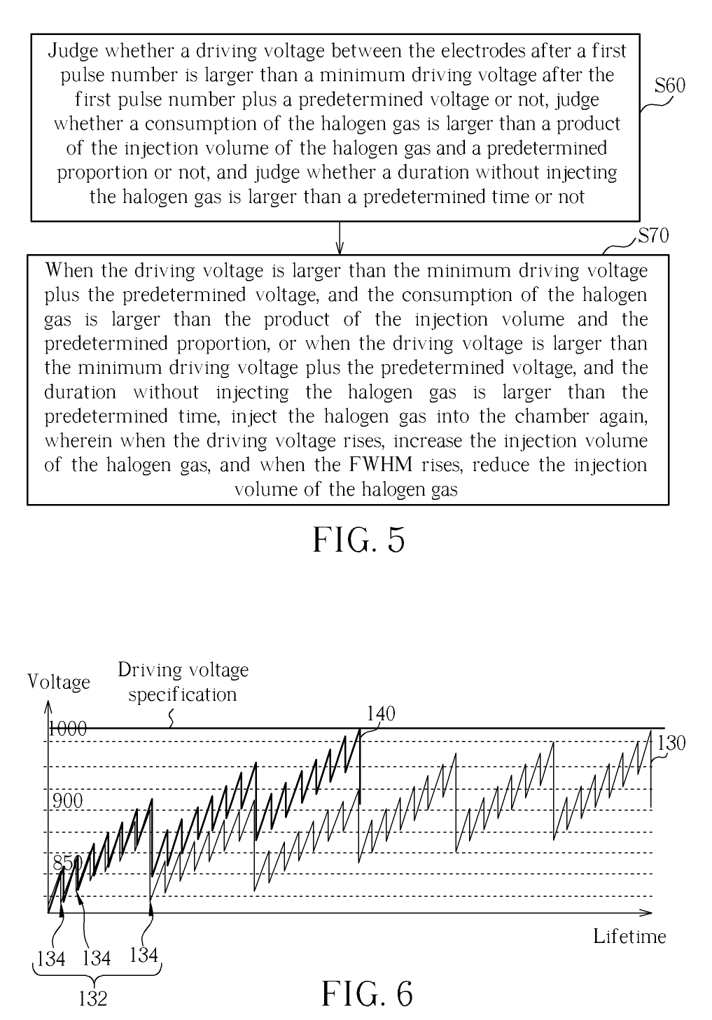

When the excimer laser system 100 has been started for a period of time, the operating method of the present invention further includes performing a gas injection method after step S50, and the excimer laser system 100 do not require shutting down while performing the gas injection method. This means that the gas injection method can be performed when the excimer laser system 100 is in operating state. Please refer to FIG. 5, and refer to FIG. 3 again. FIG. 5 is a flow chart illustrating the gas injection method according to the preferred embodiment of the present invention. As shown in FIG. 5, after the excimer laser system 100 operates for a period of time, the gas injection method of this embodiment includes:

Step S60: judge whether a driving voltage between the electrodes 108, 110 after a first pulse number is larger than a minimum driving voltage (D213) after the first pulse number plus a predetermined voltage (C163) or not, judge whether a consumption (D205) of the halogen gas is larger than a product of the injection volume of the halogen gas and a predetermined proportion (C167) or not, and judge whether a duration (D212) without injecting the halogen gas is larger than a predetermined time (C162) or not; and

Step S70: when the driving voltage is larger than the minimum driving voltage plus the predetermined voltage, and the consumption of the halogen gas is larger than the product of the injection volume and the predetermined proportion, or when the driving voltage is larger than the minimum driving voltage plus the predetermined voltage, and the duration without injecting the halogen gas is larger than the predetermined time, inject the halogen gas into the chamber 102 again, wherein when the driving voltage rises, increase the injection volume of the halogen gas, and when the FWHM rises, reduce the injection volume of the halogen gas.

In step S60, the first pulse number of this embodiment can be ten thousand times, but is not limited to this value. In addition, the consumption of the halogen gas can be the sum of a product of a first halogen consumption (C166) per million pulse number and a second pulse number (D150) and a product of a second halogen consumption (C165) per hour without injecting the halogen gas and the duration without injecting the halogen gas, which can be represented by an equation:

D205=D150×C166/1000+D212×C165/1000

where the unit of the second pulse number is million pulse numbers.

In step S70, when the fluorine in the chamber 102 is decreased so as to lower the output energy of the excimer laser system 100, the control device 118 of this embodiment will increase the driving voltage to maintain the output energy of the laser light generated by the excimer laser system 100. When the driving voltage is larger than the minimum driving voltage plus the predetermined voltage, and the consumption of the halogen gas is larger than the product of the injection volume and the predetermined proportion, or when the driving voltage is larger than the minimum driving voltage plus the predetermined voltage, and the duration without injecting the halogen gas is larger than the predetermined time, the control device 118 opens the first gas supply unit 104 to inject the halogen gas into the chamber 102. Furthermore, when the driving voltage is not larger than the minimum driving voltage plus the predetermined voltage, or when the consumption of the halogen gas is not larger than the product of the injection volume and the predetermined proportion and the duration without injecting the halogen gas is not larger than the predetermined time, the halogen gas is not injected into the chamber 102.

It should be noted that when the driving voltage rises, the gas injection method further includes at least one of a third relational equation through a sixth relational equation so as to prevent the lifetime of the electrodes from being shortened due to the sustained increase of the driving voltage. In order to avoid the sustained increase of the driving voltage and to produce the laser light with stable output, the injection volume of the halogen can be raised. For example, the third relational equation is:

C135′=1.1×C135

where C135′ is an injection volume of the halogen gas after the driving voltage rises; C135 is an injection volume of the halogen gas before the driving voltage rises; 1.1 is a proportional constant. The present invention is not limited to this value. It should be noted that when the injection volume of the halogen gas is increased, even though the driving voltage is reduced, the excimer laser system still can produce the laser light with the same output energy and the same FWHM so as to avoid the sustained increase of the driving voltage.

In addition, besides increasing the injection volume of the halogen gas, the injection number of the halogen gas also can be raised when the driving voltage rises. In other words, the condition of the driving voltage larger than the minimum voltage plus the predetermined voltage can be satisfied faster, the injection number of the halogen gas can be raised so as to more easily perform the step of injecting the halogen gas. The predetermined voltage of this embodiment can be adjusted as the fourth relational equation:

C163′=C163−10

where C163′ is a predetermined voltage set in the control device 118 after the driving voltage rises; C163 is a predetermined voltage set in the control device 118 before the driving voltage rises; 10 is a constant. The present invention is not limited to this value.

Furthermore, this embodiment also can increase the consumption of the halogen gas for judging when the driving voltage rises. Although the consumption of the halogen gas read in the control device 118 does not change, the value of the first halogen consumption stored in the control device 118 and used for judging can be increased. The consumption of the halogen gas for judging can be easily larger than the product of the injection volume of the halogen gas and the predetermined proportion so as to more easily perform the step of injecting halogen gas. The first halogen consumption of this embodiment can be adjusted as the fifth relational equation:

C166′=C166+50

where C166′ is a first halogen consumption used for judging by the control device 118 after the driving voltage increases; C166 is a first halogen consumption used for judging by the control device 118 before the driving voltage increases; 50 is a constant. The present invention is not limited to this value.

Moreover, this embodiment also can reduce the predetermined proportion set in the control device 118 when the driving voltage rises. Accordingly, the product of the injection volume of the halogen gas and the predetermined proportion becomes smaller, and the consumption of the halogen gas is easily larger than the product of the injection volume and the predetermined proportion so as to perform injecting the halogen gas. The predetermined proportion can be adjusted as the sixth relational equation:

C167′=C167−50

where C167′ is a predetermined proportion set in the control device 118 after the driving voltage rises; C167 is a predetermined proportion set in the control device 118 before the driving voltage rises; 50 is a constant. The present invention is not limited to this value.

However, when the injection volume of the halogen gas is overly large, the FWHM will increase accordingly. In order to prevent the critical dimension from being larger due to the increase of the FWHM, the gas injection method of this embodiment further includes at least one of a seventh relational equation through a tenth relational equation so as to retard the increase of the FWHM. The seventh rational equation of the gas injection method can reduce the injection volume of the halogen gas to retard the increase of the FWHM. For example, the seventh relational equation is:

C135′=0.9×C135

where C135′ is an injection volume of the halogen gas after the FWHM rises; C135 is an injection volume of the halogen gas before the FWHM rises; 0.9 is a proportional constant. The present invention is not limited to this value.

Besides reducing the injection of the halogen gas, the injection number of the halogen gas can be reduced to retard the increase of the FWHM. In other words, to retard the condition of the driving voltage larger than the minimum driving voltage plus the predetermined voltage can also retard the injection of the halogen so as to reduce the injection number of the halogen gas. The predetermined voltage of this embodiment can be adjusted as the eighth relational equation:

C163′=C163+10

where C163′ is a predetermined voltage set in the control device 118 after the FWHM rises; C163 is a predetermined voltage set in the control device 118 before the FWHM rises; 10 is a constant. The present invention is not limited to this value.

Furthermore, this embodiment also can reduce the consumption of the halogen gas for judging. This means that the value of the first halogen consumption stored in the control device 118 and used for judging can be reduced, so that the consumption of the halogen gas for judging can not be easily larger than the product of the injection volume of the halogen gas and the predetermined proportion so as to retard the injection of the halogen gas. The first halogen consumption of this embodiment can be adjusted as the ninth relational equation:

C166′=C166−50

where C166′ is a first halogen consumption used for judging by the control device 118 after the FWHM rises; C166 is a first halogen consumption used for judging by the control device 118 before the FWHM rises; 50 is a constant. The present invention is not limited to this value.

Moreover, this embodiment also can increase the predetermined proportion set in the control device 118. Accordingly, the product of the injection volume of the halogen gas and the predetermined proportion becomes larger, and the consumption of the halogen gas is not easily larger than the product of the injection volume and the predetermined proportion so as to retard the injection of the halogen gas. The predetermined proportion can be adjusted as the tenth relational equation:

C167′=C167+50

where C167′ is a predetermined proportion set in the control device 118 after the driving voltage rises; C167 is a predetermined proportion set in the control device 118 before the driving voltage rises; 50 is a constant. The present invention is not limited to this value.

As the above-mentioned description, when the driving voltage rises, the present invention uses the third relational equation through sixth relational equation to increase the injection of the halogen gas. When the FWHM rises, the present invention uses the seventh relational equation through tenth relational equation to retard the injection of the halogen gas. Furthermore, the present invention can reuse the third relational equation through the tenth relational equation in the following steps using the gas injection method to control the driving voltage and the FWHM. Therefore, the lifetime of the chamber 102 can avoid being shortened because of raising the driving voltage difference, and the critical dimension of the devices can avoid being increased due to the increase of the bandwidth of the laser light.

It should be noted that the operating method of the excimer laser system of the present invention is not limited to include performing only one time the gas injection method, and the operating method of the excimer laser system can include performing a plurality times of the gas injection method. Please refer to FIG. 6, which is a schematic diagram illustrating a lifetime curve of the excimer laser system using the operating method of the present invention and a lifetime curve of the excimer laser system according to the prior art. As shown in FIG. 6, a first curve 130 represents the lifetime of the excimer laser system operated by repeating the operating method of the present invention. Each operating method includes performing a plurality of gas injections. A plurality of sections 132 represent repeating a plurality of the operating method of the excimer laser system. A second curve 140 represent the lifetime of the excimer laser system operated by human experience according to the prior art. As compared with the prior art, the excimer laser system operated by using the operating method of the present invention can effectively extend the lifetime.

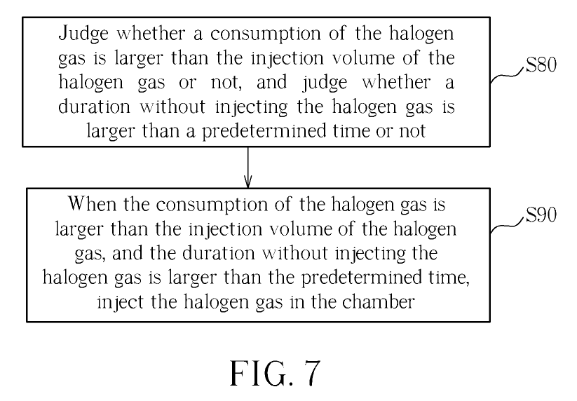

The gas injection method of the present invention is not limited to be used after the excimer laser system have been operated for a period of time, and the gas injection method can be used after the excimer laser system does not operate for a period of time. Please refer to FIG. 7, which is a flow chart illustrating a gas injection method according to another preferred embodiment of the present invention. As shown in FIG. 7, after the excimer laser system has not been operated for a period of time, the gas injection method of this embodiment includes:

Step S80: judge whether a consumption of the halogen gas is larger than the injection volume of the halogen gas or not, and judge whether a duration without injecting the halogen gas is larger than a predetermined time or not; and

Step S90: when the consumption of the halogen gas is larger than the injection volume of the halogen gas, and the duration without injecting the halogen gas is larger than the predetermined time, inject the halogen gas in the chamber.

In step S80, because this embodiment is used in the condition that the excimer laser system does not operate, the consumption of the halogen gas of this embodiment is equal to a product of a second halogen consumption per hour without injecting the halogen gas and a duration without injecting the halogen gas, and the consumption of the halogen gas of this embodiment does not include the first halogen consumption during a certain pulse number. The consumption of the halogen gas can be represented by an equation:

D205=D212×C165/1000

In step S90, because the excimer laser system does not operate, the halogen gas can be injected after a period of time.

In summary, the operating method of the excimer laser system of the present invention provides the third relational equation through sixth relational equation to increase the injection of the halogen gas and reduce the driving voltage when the driving voltage rises. In addition, the present invention further provides the seventh relational equation through tenth relational equation to reduce the injection of the halogen gas so as to retard the increase of the FWHM when the FWHM rises. Therefore, the lifetime of the excimer laser system can be extended.

Those skilled in the art will readily observe that numerous modifications and alterations of the device and method may be made while retaining the teachings of the invention.

What is claimed is:

1. An operating method of an excimer laser system, the excimer laser system comprising a chamber, a first gas supply unit for providing a halogen gas and a second gas supply unit for providing a mixed gas, the mixed gas comprising a first inert gas and a second inert gas, and the chamber filled with a remaining reaction gas, the operating method comprising:
injecting the halogen gas with an injection volume into the chamber until a pressure of the chamber is a total pressure, and the halogen gas in the chamber having a halogen pressure; and
providing a driving voltage between two electrodes in the chamber so as to start the excimer laser system, wherein the halogen pressure and a full width half maximum (FWHM) of a laser light generated by the excimer laser system are limited to have negative relation, and the halogen pressure and the driving voltage are limited to have positive relation.

2. The operating method of claim 1, wherein the total pressure and the driving voltage have positive correlation.

3. The operating method of claim 2, wherein the halogen pressure is equal to a product of the FWHM of the excimer laser system and a first coefficient plus a product of the driving voltage and a second coefficient plus a first constant, and the total pressure is equal to a product of the driving voltage and a third coefficient plus a second constant.

4. The operating method of claim 2, further comprising performing a gas injection method after starting the excimer laser system, wherein the gas injection method comprises:
when the driving voltage gained after providing a first pulse number is larger than a minimum driving voltage after providing the first pulse number plus a predetermined voltage, and a consumption of the halogen gas is larger than the injection volume multiplying a predetermined proportion, or when the driving voltage is larger than the minimum driving voltage plus the predetermined voltage, and a duration without injecting the halogen, injecting the halogen gas into the chamber.

5. The operating method of claim 4, wherein when the driving voltage rises, increase the injection volume of the halogen gas.

6. The operating method of claim 4, wherein when the driving voltage rises, reduce the predetermined voltage.

7. The operating method of claim 4, wherein when the driving voltage rises, increase the consumption of the halogen gas for judging.

8. The operating method of claim 4, wherein when the driving voltage rises, reduce the predetermined proportion.

9. The operating method of claim 4, wherein when the FWHM rises, reduce the injection volume of the halogen gas.

10. The operating method of claim 4, wherein when the FWHM rises, increase the predetermined voltage.

11. The operating method of claim 4, wherein when the FWHM rises, reduce the consumption of the halogen gas for judging.

12. The operating method of claim 4, wherein when the FWHM rises, increase the predetermined proportion.

13. The operating method of claim 1, wherein the halogen gas is fluorine, the first inert gas is krypton, and the second inert gas is neon.

14. The operating method of claim 1, wherein before injecting the halogen gas, the operating method further comprises:
exhausting the remaining reaction gas in the chamber until the pressure of the chamber is a first pressure;
injecting the halogen gas into the chamber until the pressure of the chamber is a second pressure; and
injecting the mixed gas into the chamber until the pressure of the chamber is a third pressure.
